(19) United States
(12) Patent Application Publication
(10) Pub. No.: US 2002/0087364 A1
(43) Pub. Date: Jul. 4, 2002

(54) System and method for enabling real time underwriting of insurance policies

(76) Inventors: Andrew S. Lerner, New York, NY (US); Robert M. Lichten, Port Washington, NY (US)

Correspondence Address: EPSTEIN, EDELL, SHAPIRO, FINNAN & LYTLE, LLC, 1901 RESEARCH BOULEVARD, SUITE 400, ROCKVILLE, MD, 20850, US

(21) Appl. No.: 09/986,204

(22) Filed: Nov. 7, 2001

Related U.S. Application Data
(60) Provisional application No. 60/246,073, filed on Nov. 7, 2000.

(51) Int. Cl. G06F 17/60

(52) U.S. Cl. 705/4

(57) ABSTRACT

The system of the present invention enables an insurance company or other provider to underwrite a life insurance policy based on relevant insurability information or factors and in real time for potential customers directly or indirectly accessing the system via a network. The insurability information includes medical records and medical claims that are typically maintained and accessed from potential customer healthcare provider or other third party databases and other information provided by the potential customers. The system retrieves and utilizes this information to produce an underwriting score or value, where information gathered from the potential customer is compared to information within an insurer database. The score is computed based on a formula that takes into consideration the importance of the information in determining mortality risk, and is subsequently used in determining whether or not to underwrite the life insurance policy and the corresponding policy price.

### CROSS-REFERENCE TO RELATED APPLICATIONS

This application claims priority from U.S. Provisional Patent Application Serial No. 60/246,073, entitled “System And Method For Enabling Real Time Underwriting Of Insurance Policies” and filed Nov. 7, 2000. The disclosure of that provisional application is incorporated herein by reference in its entirety.

### BACKGROUND OF THE INVENTION

1. Technical Field

The present invention pertains to a computer system and method for determining, in real time, an individual's eligibility for insurance or other policies. In particular, the present invention pertains to an information collection and assessment tool for use in conjunction with a network, such as the Internet, that allows insurers to assess the eligibility of an applicant and issue a life insurance policy to individuals over the network.

2. Discussion of Related Art

Currently, life insurance companies underwrite policies by conducting long medical interviews with potential customers as well as having a doctor or medical technician, hired by the insurance company, perform a medical examination of a customer and/or conduct a blood and/or urine test. Underwriting is the procedure by which an insurance company assesses the risk to be assumed. In the case of a life insurance company, the risk is the timing of the death of the insured.

The above-described underwriting process suffers from several disadvantages. In particular, the process is time consuming while the purchase of an underwritten life insurance policy typically cannot be consummated during a single meeting or via a computer session on a Web site. Further, the process requires the potential customers to interact and deal with unfamiliar medical personnel.

### OBJECTS AND SUMMARY OF THE INVENTION

Accordingly, it is an object of the present invention to collect and assess information pertaining to the insurability of life insurance applicants via a network.

It is another object of the present invention to quantitatively assess individual insurability risk factors and offer a binding life insurance policy to a potential customer via an automated tool.

Yet another object of the present invention is to access third party information to determine in real time the insurability of an applicant.

Still another object of the present invention is to issue binding life insurance policies to qualified applicants over a network.

The aforesaid objects are achieved individually and/or in combination, and it is not intended that the present invention be construed as requiring two or more of the objects to be combined unless expressly required by the claims attached hereto.

According to the present invention, a computer system enables an insurance company or other provider to underwrite a life insurance policy (e.g., term, universal, etc.) in real time for potential customers based on relevant insurability information or factors. The insurability information includes medical records and medical claims that are typically maintained and accessed from potential customer healthcare provider (e.g., Health Maintenance Organization, primary care physician, etc.) or other third party databases and other information provided by the potential customers (e.g., age, sex, state of residence, medical and family history, current medical condition, lifestyle, etc.). The computer system retrieves and utilizes this information to produce an underwriting score or value, where information gathered from the potential customer is compared to information within an insurer database. The score is computed based on a formula that takes into consideration the importance of the information in determining mortality risk, and is subsequently used in determining whether or not to underwrite the life insurance policy and the corresponding policy price. The present invention system is preferably utilized with respect to life insurance, but may be employed to underwrite and/or issue all forms of insurance (e.g., homeowners, personal property and automobile insurance, medical insurance, etc.) or other contractual obligations (e.g., loans, financial arrangements, etc.) in substantially the same manner described above.

The present invention provides several advantages. For example, if the information available in the medical records and claims is sufficient for the insurer to underwrite the potential customer life insurance policy, the potential customer may obviate the medical examination and/or blood and/or urine tests. Further, if additional medical information is required, the potential customer healthcare provider may conduct an examination or test, thereby reducing costs for the insurer.

### BRIEF DESCRIPTION OF THE DRAWINGS

FIG. 1 is a schematic diagram of a server system employing the insurability assessment tool according to the present invention and accessible by end-users via a communications network.

FIGS. 2-3 are a procedural flow chart illustrating the manner in which the insurability assessment tool collects insurability information and renders a decision with respect to life insurance policy issuance according to the present invention.

FIG. 4 is a procedural flow chart illustrating the manner in which individual insurability factors are assessed to determine an insurability score according to the present invention.

### DETAILED DESCRIPTION OF THE PREFERRED EMBODIMENTS

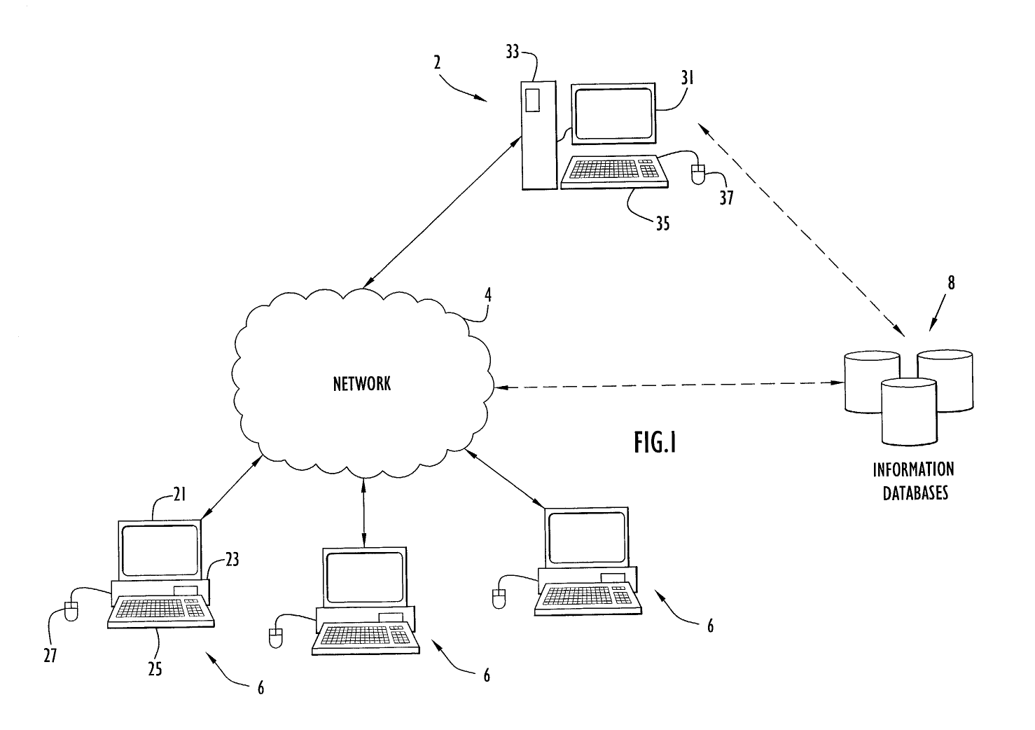

A system employing the assessment tool of the present invention is illustrated in FIG. 1. Specifically, the system preferably includes a server computer system 2 in communication with or connected to a network 4, such as the Internet, end-user computer systems 6 accessing the server via the network and one or more information systems or databases 8 which may be accessed by the server computer system 2 either via network 4 or an alternative connection (e.g., direct line, another network, hardwired, etc.). These databases are preferably maintained by third parties (e.g., Health Maintenance Organization (HMO), primary care physician, hospitals, etc.) and contain information relevant to the insurability of a potential customer for life insurance. The information typically includes HMO claims records, medical laboratory test reports and/or computerized results from previous hospital or doctor office examinations. The nature of the particular records stored and accessed may vary widely, depending upon the nature of the insurance or policy desired.

The end-user computer systems are typically implemented by conventional personal or other suitable computer systems preferably equipped with display or monitor 21, a base 23 (i.e., including the processor memories and internal or external communications devices (e.g., modem, network cards, etc.)), a keyboard 25 and optional mouse 27 or other input device. End-user systems 6 each include software (e.g., operating system, Internet browser, etc.) to communicate with server system 2, and appropriate components (e.g., processor, disk storage or hard drive, etc.) having sufficient processing and storage capabilities to effectively execute the software. The end-user systems may utilize any of the major platforms (e.g., Linux, Macintosh, Unix, OS2, Windows, etc.). An end-user system 6 may be operated directly by a potential customer to access a website hosted on server system 2 to purchase a desired life insurance policy. Alternatively, an end-user system 6 may be manned by an operator that accesses the server website and verbally communicates with a potential customer via a telephone (e.g., the customer may dial a toll free or other telephone number). In addition, an end-user system may be in the form of a voice or telephone keypad driven computer system that accesses the sever and transfers information in response to voice commands or telephone keypad entries (e.g., a potential customer may dial a telephone number to access the end-user system). The server system may alternatively include this type of voice or telephone keypad responsive system and receive calls directly from the potential customer. The alternative end-user systems (e.g., manned and voice or telephone keypad responsive) are particularly suited for customers without network access. The manner in which a potential customer is assessed and a life insurance policy issued is similar for the various end-user systems (e.g., customer operated, manned and voice or telephone keypad responsive) as described below.

Server system 2 is typically implemented by a conventional personal or other suitable computer system preferably equipped with a display or monitor 31, a base 33 (i.e., including the processor, memories and internal or external communication devices (e.g., modem, network cards, etc.)), a keyboard 35 and optional mouse 37 or other input device. The server system includes software (e.g., operating system, server software, assessment tool, etc.) to communicate with end-user and information systems 6, 8 and process life insurance policy underwriting and issuance requests, and appropriate components (e.g., processor, disk storage or hard drive, etc.) having sufficient processing and storage capabilities to effectively execute the assessment tool software. The server system may utilize any of the commercially available operating systems and/or server software, and, under software control, implements the assessment tool of the present invention for processing requests from the end-user computer systems to underwrite and/or issue life insurance and other policies.

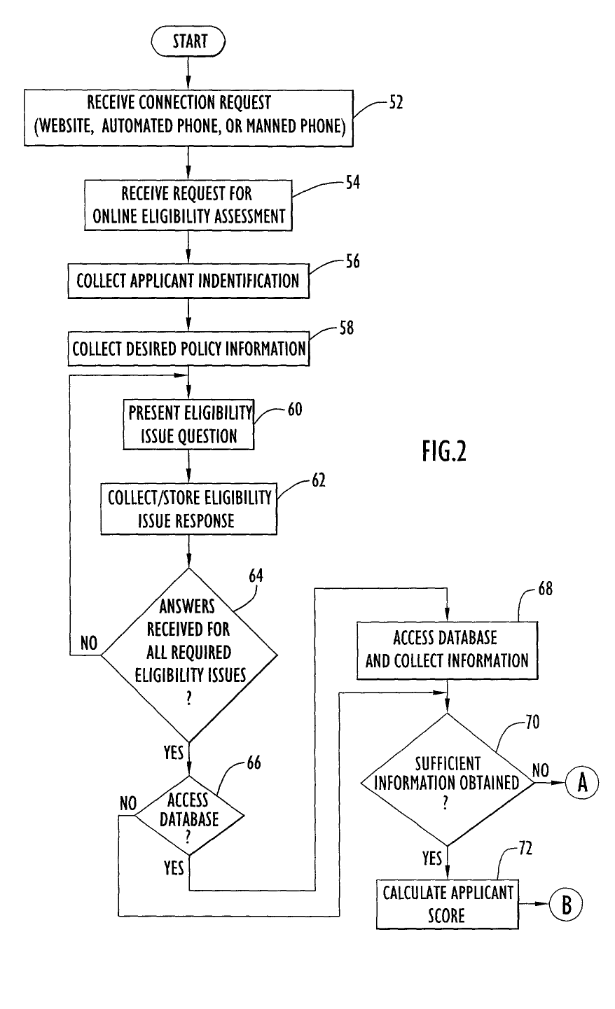

The manner in which the sever system and assessment tool process life insurance underwriting and issuance requests is illustrated in FIG. 2. Initially, server system 2 receives a connection request at step 52 and establishes a session with a requesting enduser computer system 6. A potential customer may utilize any interface to conduct a session (e.g., a World Wide Web (WWW) based website, an automated response telephone system, verbal request via a human operated telephone bank where the operator utilizes an end-user computer system, etc.). In the case of a website interface, the potential customer operates an end-user system and accesses the website to select an option that allows the user to designate and apply for a desired life insurance policy via a web browser interface. Alternatively, the potential customer may call a telephone number associated with an automated response telephone system and conduct a session verbally and/or via a touch tone keypad to apply for the desired policy, or call a telephone number associated with an operator with physical access to an end-user system accessing the server and apply for the desired policy via verbal communication with the operator.

The server receives a request for an eligibility assessment at step 54 (e.g., via any of the above-described interfaces) and queries the potential customer for personal identification and contact information (e.g., name, address, telephone number, social security number, prior addresses, etc.) at step 56. This information may be utilized to uniquely identify the potential customer within the system and ensure retrieval of appropriate information for that customer from the databases as described below.

The server system subsequently collects information relating to a desired life insurance policy (e.g., policy type, coverage amount, term, etc.) at step 58. Once the policy specifics have been identified, the server system prompts the user for responses to policy specific questions (e.g., age, sex, state of residence, medical and family history (e.g., history of cancer, heart disease, etc.), current medical condition and lifestyle (e.g., occupation, participation in dangerous recreational activities, use of tobacco or other substances (e.g., drugs, cigars, cigarettes, pipes, etc.), etc.), etc.). In particular, the applicant is presented with an eligibility question at step 60 while the response to that question is received by the server system and recorded at step 62. Eligibility questions are presented to the potential customer until a response has been received with respect to each required eligibility question as determined at step 64. The questions presented to a potential customer may be dynamically tailored by the system for a particular application. For example, if an applicant indicates a history of heart related ailments, additional questions relating to heart disease may be presented.

The server system may further request permission from the potential customer to access customer medical records and claims from an HMO, primary care provider or other organization. This request is optional and depends on various legal and other issues. The medical information may be stored in databases or information systems 8 (e.g., HMO database, primary care databases, etc.) accessible by server system 2. If the server system receives permission or may otherwise validly access customer medical information as determined at step 66, the appropriate medical information for the customer is retrieved from databases 8 at step 68. The database access basically provides the system with sufficient information to facilitate underwriting and issuance of the life insurance policy in real time. The server system determines at step 70 whether or not sufficient information has been obtained from the customer and/or databases to render a decision. When insufficient information is available, the system informs the customer at step 104 that additional information is required to render a decision and saves session information (e.g., policy information, customer information, etc.) at step 124 for later access (e.g., via an account or other identifier) prior to terminating the session. The system may inform the customer of the additional information required and/or may provide contact information for arrangement of tests and/or transfer of additional information to the insurer. Alternatively, the potential customer may enter the additional information to enable the system to render a decision as described below. If sufficient information is received, the server system quantitatively assesses and analyzes the information at step 72 to determine an eligibility score or value with respect to the insurability issues of interest.

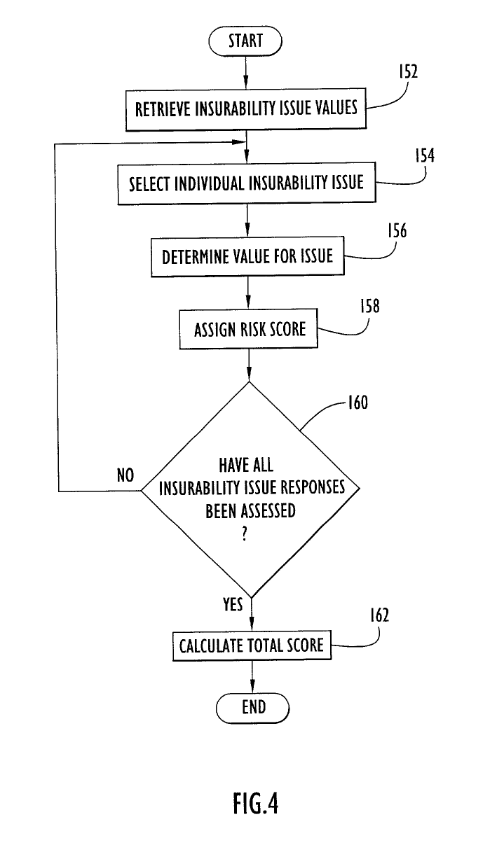

The system basically employs an algorithm based on insurer underwriting criteria to evaluate the medical information retrieved from databases 8 and the information provided by the potential customer and produce the underwriting score or value. The manner in which the system determines the score is illustrated in FIG. 4. Specifically, once sufficient information has been received with respect to the insurability issues or factors associated with a selected life insurance policy and corresponding policy options, the system retrieves the recorded responses at step 152 and evaluates the retrieved information. A response associated with an insurability issue is selected at step 154, and a risk assessment value is determined at step 156. The value is assigned to the insurability issue at step 158. This process is repeated until all insurability issues have been assessed and assigned an assessment value as determined at step 160. The underwriting criteria may assign points based on medical test results or other information. By way of example, low blood pressure may be assigned one point, moderate blood pressure may be assigned three points and high blood pressure may be assigned five points. Further, a potential customer may receive points proportional to the level of cholesterol in their blood. The greater the cholesterol level, the greater the number of points the potential customer is assigned and vice versa. The risk assessment values may further be weighted based upon various factors. A total risk factor or eligibility score is calculated by adding the individual assessment values assigned to the potential customer at step 162 after review of the medical and application information. This total score represents a comprehensive quantified assessment of the potential customer insurability, and is used to make decisions on whether or not to underwrite a life insurance policy and to determine the price of the policy as described below. An insurer typically sets a threshold score below which the insurer underwrites a life insurance policy. The number of points below the threshold may be a factor in determining the price of the policy.

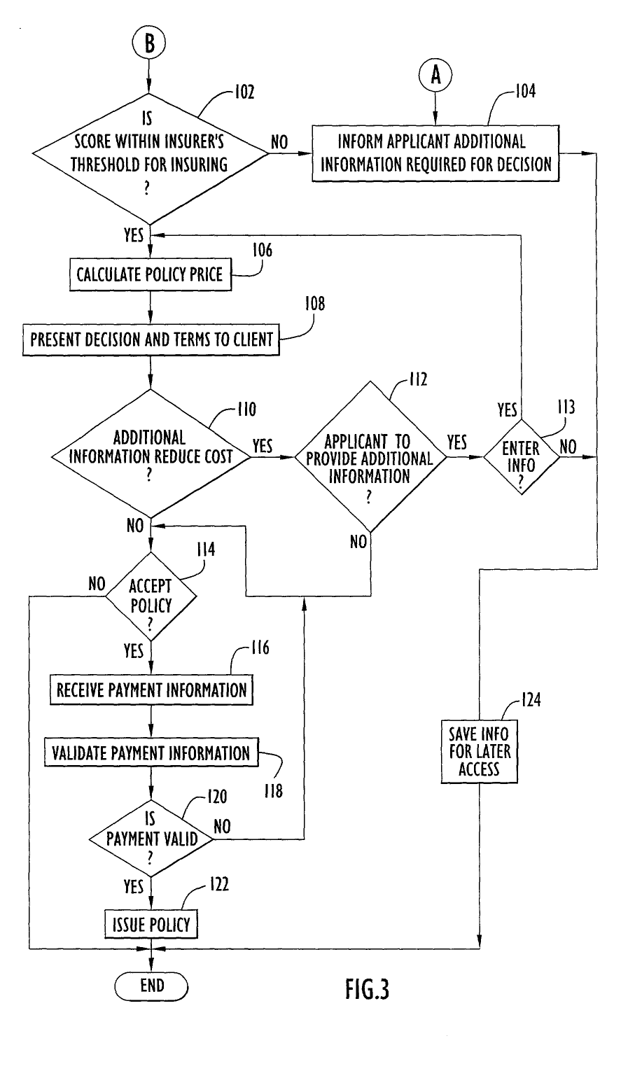

Referring back to FIG. 3, if the total score determined by the system is below the insurer threshold with respect to the requested policy as determined at step 102, a policy price is calculated based on the score at step 106 and is commensurate with the associated risk. The decision, price and terms of the proposed life insurance policy are presented to the potential customer at step 108. Thus, the system provides an automated underwriting process that accesses appropriate medical and other information from third party databases to render a decision, generally without human intervention by the insurer. If the system determines at step 102 that the total score is equal to or in excess of the insurer threshold, the system informs the potential customer at step 104 that additional information is required to render a decision and saves session information at step 124 prior to terminating the session as described above. The potential customer may be provided with the type of information required and/or contact information to arrange tests and/or transfer of additional information to the insurer. Alternatively, the potential customer may enter the additional information, while the system re-computes the score as described above.

When a potential customer score is below the insurer threshold, the cost of the life insurance policy may be reduced by the customer providing additional information. If the system determines at step 110 that the cost of the policy may be reduced by providing additional information (e.g., medical tests or claims, administration of certain medical tests or examinations by customer HMO or primary care provider, etc.), the system informs the potential customer of the nature of the additional information required and provides contact information by which the potential customer may arrange tests and/or transfer of additional information to the insurer. If the customer is to provide additional information as determined at step 112, the system determines at step 113 whether or not the information is to be entered. When the additional information may be entered, the system re-computes the policy price as described above. If the information is not available for entry, the system saves session information at step 124 as described above and terminates the session to enable the customer to obtain the additional information.

If the cost of the policy may not be reduced or the customer decides not to provide additional information, the system enables the potential customer to purchase or accept the proposed life insurance policy. If the policy is accepted as determined at step 114, the system receives payment information from the potential customer at step 116. The payment information may be in the form of authorization for credit or debit card deduction or any other arrangement. The system subsequently validates the payment information at step 118. If the system determines that the payment is valid at step 120, the policy is issued at step 122 and is a binding obligation of the insurer according to the terms of the policy, provided that the personal medical information supplied by the potential customer is valid and accurate. If the payment is invalid, the potential customer is provided with the opportunity to accept or reject the proposed policy and to resubmit payment information. When the policy is rejected as determined at step 114, the session is terminated. However, the system may save session information for later access prior to terminating the session as described above.

The present invention is basically implemented by a server or other computer system under software control, and enables life insurance or other policies to be issued in real time in a single automated session via access of relevant third party information (e.g., medical or other information from an HMO or primary care physician, etc.) sufficient to facilitate an acceptable underwriting risk assessment to render a decision.

It will be appreciated that the embodiments described above and illustrated in the drawings represent only a few of the many ways of implementing a system and method for enabling real time underwriting of insurance policies.

The end-user and server computer systems of the present invention may be implemented by any quantity of any personal or other type of computer system (e.g., IBM-compatible, Apple, Macintosh, laptop, palm pilot, etc.). The computer systems of the present invention may include any commercially available operating system (e.g., Windows, OS/2, Unix, Linux, etc.). The computer systems of the present invention may further include any commercially available or custom software (e.g., server software, browser software, tool software, etc.), and any types of input devices (e.g., keyboard, mouse, voice recognition, touch screen, etc.). It is to be understood that the software for the computer systems of the present invention may be implemented in any desired computer language and could be developed by one of ordinary skill in the computer arts based on the functional descriptions contained in the specification and flow charts illustrated in the drawings. The computer systems of the present invention may alternatively be implemented by hardware or other processing circuitry. The various functions of the computer systems and databases may be distributed in any manner among any quantity of computers, processing systems and/or software and/or hardware modules. The software and/or algorithms described above and illustrated in the flow charts may be modified in any manner that accomplishes the functions described herein.

The network may be implemented by any communications network (e.g., LAN, WAN, Internet, Intranet, etc.). The server and end-user computer systems may include any conventional or other communications devices to communicate over the network. The databases may be implemented by any quantity of conventional or other databases, storage structures (e.g., file, data structure, etc.) or information systems, may be arranged and/or accessed in any fashion (e.g., via any desired keys or identifiers) and may store any desired information (e.g., medical, automotive, financial or credit, etc.) for a particular application. The databases may be local to or resident on the present invention server, and may be maintained and/or refreshed or updated with appropriate information from third parties or any other source at any desired intervals (e.g., hourly, daily, weekly, etc.). Alternatively, the databases may be maintained by third parties (e.g., HMO, primary care physician, hospital, credit agency, motor vehicle agency, etc.) having information associated with a particular application. The databases may be remote from and in communication with the present invention server via any desired communications medium (e.g., modem, network, direct line, etc.). Moreover, the databases may reside on a stand-alone system or any quantity of systems connected via any type of communication medium or network (e.g., modem, direct line, LAN, WAN, Internet, etc.).

The assessment tool may be implemented by any quantity of computer systems, and may reside on the server, end-user or other third-party computer system or any combination of these computer systems. The assessment tool may be available on recorded medium (e.g., floppy diskettes, CD-ROM, memory devices, etc.) for use on stand-alone systems or systems connected by a network, or may be downloaded (e.g., in the form of carrier waves, packets, etc.) to systems from a network. The assessment tool inquiries and resulting information may be displayed and arranged on end-user devices in any fashion. The assessment tool may utilize any display mechanisms to prompt, receive and/or display information to a potential customer (e.g., windows, menus, line prompts, etc.).

The present invention is not limited to the applications described herein, but may be used in a manner similar to that described above to assess eligibility on a real-time basis for a multitude of automated policy or other transactions relating to contractual obligations. Information may be entered into the assessment tool via any desired input mechanism (e.g., menu driven windows, voice recognition, telephone keypads, touch screens, stylus pens, or any other device capable of entering information in a manner that may be interpreted by a computer system). Further, the present invention may include voice or telephone keypad responsive systems to enable access by telephone, while enduser systems may be manned by an operator to enable use of the system via telephone calls to the operator. Alternatively, the system may include any interface to accommodate various access devices and mediums (e.g., wireless devices, cellular telephones, pagers, palm pilots, etc.).

The potential customer may be uniquely identified to the system by using any suitable identifier having any quantity of any alphanumeric or other characters or symbols. The identifier may be used to access information for that customer from the databases. The system may receive and provide any desired information to identify a desired policy (e.g., type of policy, per event and/or lifetime insured value, nature of payments to the insured, per event fixed or percentage based deductible, annual fixed or percentage based deductible, events and/or conditions covered, etc.).

The system may retrieve any desired information from a potential customer and may utilize any quantity of any types of inquiries or questions. The system may dynamically determine and present appropriate questions based on the policy requested and/or responses to prior inquiries. Further, question content may vary where order of presentation to a potential customer may be random, asked in association with a single insurability issue, driven by responses to previous responses, purposefully disjoint, or based upon a combination of the above, so as to solicit pertinent responses from a potential customer. The responses may be of any format, and may be stored in any suitable storage structure (e.g., file, data structure, array, tables, database, etc.) in any desired format or arrangement. The system may further store any desired session information (e.g., policy information, customer information, etc.) in any suitable storage structure (e.g., file, data structure, array, tables, databases, etc.) for later access by the system and/or potential customer via any suitable technique (e.g., log on account, identifier, etc.).

The assessment values for the factors may have any desired value (e.g., integer, real, positive, negative, etc.) and be assigned to particular issues in any desired fashion. The assessment values may be weighted in any desired fashion and may be combined in any manner (e.g., multiplied, accumulated, logically combined, percentages, etc.) to achieve a score representing eligibility. The assessment values may be stored in any desired storage structure in any desired fashion (e.g., arrays, look-up or other tables, databases, etc.) and/or may be calculated from received responses and/or information. Each issue may be associated with one or more assessment values where the values may be combined in any fashion to determine a value for that issue. The assessment values may be associated with any desired units (e.g., points, etc.).

The system may utilize any quantity of thresholds of any desired value (e.g., integer, real, positive, negative, etc.) to determine eligibility for a particular application. The thresholds may be a single value or a value range. Eligibility may be based on any desired results of comparisons of the score to the threshold (e.g., greater than, less than, equal to, within or outside a range, etc.). The score may be processed in any fashion for comparison to the threshold (e.g., weighted, multiplied, etc.). Further, the system may utilize thresholds for each individual issue and determine eligibility based on comparisons of each issue score to a threshold or any combination of the individual comparisons. The threshold values may be preset or dynamically generated based on various parameters.

The system may determine policy prices in any desired fashion based on the eligibility score and/or other factors (e.g., table look-up, formula or algorithm, etc.). The prices may be stored or calculated by the system, or accessed from a remote system (e.g., insurer system, database, etc.) having various policy information. The system may determine reductions in pricing in any desired fashion (e.g., score level in relation to a threshold, detecting lack of particular information reducing risk involved, etc.). The system may utilize any quantity of any desired information in order to render a decision, and require any quantity of any information in order to render the decision.

The system may display a policy for acceptance in any desired fashion and with any additional information. Further, the policy may be accepted by any type of appropriate user response. The system may display any contractual or other obligations and may verify or confirm acceptance by the potential customer (e.g., an additional display inquiring as to whether the potential customer is sure the customer wants to purchase the policy).

The system may accept any desired electronic or other forms of payment (e.g., credit card, debit card, cash card payments, wired money transfers, etc.). Alternatively, the customer may be billed and remit a check or other form of payment. The payments may be lump sum or prorated based upon a monthly, annual, or other periodic schedule. Further, the payments may be validated in any fashion (e.g., accessing appropriate bank or credit agency information, etc.).

The policies may be issued manually or electronically in any desired fashion (e.g., transmission by dynamic web page, fax, electronic mail, printed and distributed manually via ground mail and/or private couriers, etc.). The system may request the potential customer to acknowledge that the customer has read and agrees to policy terms. The system may display the policy terms, while the acknowledgement may be provided as an electronic acknowledgment at time of issuance, or provided by a subsequent written reply after the policy is issued. Further, the system may generate a receipt (e.g., electronic mail, downloaded file for printing, web page for printing, fax receipt to potential customer, etc.) at time of acceptance or issuance of the policy to confirm the transaction. The receipt may include any desired information (e.g., policy number, confirmation number, etc.).

The system preferably handles requests and issues policies in real time. However, the system may alternatively process requests in batch or any other mode. For example, a potential customer may submit a request and the system may contact the potential customer at a later time to offer the policy (e.g., contact the customer via electronic mail or any communications device to render the decision, the system may provide an identifier to enable the customer to access the decision and purchase the policy at a later time, etc.). Alternatively, the system may store and process a series of requests in batch mode.

From the foregoing description, it will be appreciated that the invention makes available a novel system and method for enabling real time underwriting of insurance policies, wherein the present invention determines insurability and issues policies in accordance with insurer criteria on a real-time basis as the result of a single automated session.

Having described preferred embodiments of a new and improved system and method for enabling real time underwriting of insurance policies, it is believed that other modifications, variations and changes will be suggested to those skilled in the art in view of the teachings set forth herein. It is therefore to be understood that all such variations, modifications and changes are believed to fall within the scope of the present invention as defined by the appended claims.

What is claimed is:

1. A system for underwriting and issuing insurance policies over a network to potential customers accessing said system via end-user systems, said system comprising:
a processing system to process requests received over said network from said end-user systems to underwrite and issue insurance policies, wherein said processing system includes:
a customer interface module to facilitate transference of customer and policy information over said network between said system and a potential customer;
an access module to access a storage unit including third party information and retrieve said third party information associated with said potential customer and relevant to underwriting of an insurance policy;
an assessment module to evaluate said retrieved third party information and information received from said potential customer and determine eligibility of said potential customer for said insurance policy; and
a policy module to issue said insurance policy to said potential customer over said network in accordance with said customer information and said assessment module determining that said potential customer is eligible for said insurance policy.

2. The system of claim 1 wherein said network is the Internet.

3. The system of claim 1 wherein said insurance policy is a life insurance policy.

4. The system of claim 3 wherein said storage unit is remote from said processing system and maintained by said third party, and wherein said storage unit includes medical information associated with said potential customer.

5. The system of claim 1 wherein said customer interface module includes:
a query module to generate and facilitate transmission of requests for said customer and policy information over said network to said potential customer; and
a response storage module to store said customer and policy information received from said potential customer in response to said requests.

6. The system of claim 1 wherein said access module includes:
a permission module to request authorization from said potential customer to access said third party information; and
a retrieval module to retrieve said third party information associated with said potential customer and relevant to underwriting of said insurance policy in response to receiving authorization from said potential customer.

7. The system of claim 1 wherein said assessment module includes:
an information decision module to determine the presence of sufficient information to determine eligibility of said potential customer for said insurance policy; and
a customer information module to request additional information from said potential customer in response to the presence of insufficient information.

8. The system of claim 1 wherein said assessment module includes:
an evaluation module to evaluate said retrieved third party information and information received from said potential customer and determine an assessment value indicating eligibility of said potential customer for said insurance policy.

9. The system of claim 8 where in s aid third party information and said information retrieved from said potential customer include a plurality of r isk data items relating to eligibility of said potential customer for said insurance policy, and said evaluation module includes:
an assignment module to determine and assign a risk value to each risk data item relating to said potential customer; and
a value module to accumulate each assigned risk value and produce a total value representing said assessment value.

10. The system of claim 8 wherein said assessment module further includes:
an underwriting module to compare said assessment value to a policy threshold value and to determine eligibility of said potential customer for said insurance policy based on said comparison.

11. The system of claim 10 wherein said policy module includes:
a price module to determine a price of said insurance policy based on a difference between said assessment value and said policy threshold.

12. The system of claim 11 wherein said policy module further includes:
a price reduction module to determine a reduction in said insurance policy price in accordance with additional information supplied by said potential customer.

13. The system of claim 1 wherein said policy module includes:
an offer module to enable said potential customer to purchase said insurance policy in response to said assessment module determining said potential customer is eligible for that insurance policy;
a payment module to receive and validate payment information from said potential customer in response to acceptance of said insurance policy by said potential customer; and
an issuance module to issue said insurance policy over said network to said potential customer in response to valid payment information.

14. A method of underwriting and issuing insurance policies over a network to potential customers accessing said network via end-user systems, said method comprising:
(a) facilitating communications with a potential customer to transfer customer and policy information over said network;
(b) accessing a storage unit including third party information and retrieving said third party information associated with said potential customer and relevant to underwriting of an insurance policy;
(c) evaluating said retrieved third party information and information received from said potential customer and determining eligibility of said potential customer for said insurance policy; and
(d) issuing said insurance policy to said potential customer over said network in accordance with said customer information and said determination indicating that said potential customer is eligible for said insurance policy.

15. The method of claim 14 wherein said network is the Internet.

16. The method of claim 14 wherein said insurance policy is a life insurance policy.

17. The method of claim 16 wherein said storage unit is remotely located and maintained by said third party, and wherein said storage unit includes medical information associated with said potential customer.

18. The method of claim 14 wherein step (a) further includes:
(a.1) generating and facilitating transmission of requests for said customer and policy information over said network to said potential customer; and
(a.2) storing said customer and policy information received from said potential customer in response to said requests.

19. The method of claim 14 wherein step (c) further includes:
(c.1) determining the presence of sufficient information to determine eligibility of said potential customer for said insurance policy; and
(c.2) requesting additional information from said potential customer in response to the presence of insufficient information.

20. The method of claim 14 wherein step (b) further includes:
(b1) requesting authorization from said potential customer to access said third party information; and
(b.2) retrieving said third party information associated with said potential customer and relevant to underwriting of said insurance policy in response to receiving authorization from said potential customer.

21. The method of claim 14 wherein step (c) further includes:
(c.1) evaluating said retrieved third party information and information received from said potential customer and determining an assessment value indicating eligibility of said potential customer for said insurance policy.

22. The method of claim 21 wherein said third party information and said information retrieved from said potential customer include a plurality of risk data items relating to eligibility of said potential customer for said insurance policy, and step (c.1) further includes:
(c.1.1) determining and assigning a risk value to each risk data item relating to said potential customer; and
(c.1.2) accumulating each assigned risk value to produce a total value representing said assessment value.

23. The method of claim 21 wherein step (c.1) further includes:
(c.1.1) comparing said assessment value to a policy threshold value and determining eligibility of said potential customer for said insurance policy based on said comparison.

24. The method of claim 23 wherein step (d) further includes:
(d.1) determining a price of said insurance policy based on a difference between said assessment value and said policy threshold.

25. The method of claim 24 wherein step (d.1) further includes:
(d.1.1) determining a reduction in said insurance policy price in accordance with additional information supplied by said potential customer.

26. The method of claim 14 wherein step (d) further includes:
(d.1) enabling said potential customer to purchase said insurance policy in response to determining that said potential customer is eligible for said insurance policy;
(d.2) receiving and validating payment information from said potential customer in response to acceptance of said insurance policy by said potential customer; and
(d.3) issuing said insurance policy over said network to said potential customer in response to valid payment information.

27. A system for underwriting and issuing insurance policies over a network to potential customers accessing said system via end-user systems, said system comprising:
customer interface means for facilitating transference of customer and policy information over said network between said system and a potential customer;
access means for accessing storage means storing third party information and for retrieving said third party information associated with said potential customer and relevant to underwriting of an insurance policy;
assessment means for evaluating said retrieved third party information and information received from said potential customer and determining eligibility of said potential customer for said insurance policy; and
policy means for issuing said insurance policy to said potential customer over said network in accordance with said customer information and said assessment means determining that said potential customer is eligible for said insurance policy.

28. The system of claim 27 wherein said network is the Internet.

29. The system of claim 27 wherein said insurance policy is a life insurance policy.

30. The system of claim 29 wherein said storage means is remote from said access means and maintained by said third party, and wherein said storage means stores medical information associated with said potential customer.

31. The system of claim 27 wherein said customer interface means includes:
query means for generating and facilitating transmission of requests for said customer and policy information over said network to said potential customer; and
response storage means for storing said customer and policy information received from said potential customer in response to said requests.

32. The system of claim 27 wherein said access means includes:
permission means for requesting authorization from said potential customer to access said third party information; and
retrieval means for retrieving said third party information associated with said potential customer and relevant to underwriting of said insurance policy in response to receiving authorization from said potential customer.

33. The system of claim 27 wherein said assessment means includes:
information decision means for determining the presence of sufficient information to determine eligibility of said potential customer for said insurance policy; and
customer information means for requesting additional information from said potential customer in response to the presence of insufficient information.

34. The system of claim 27 wherein said assessment means includes:
evaluation means for evaluating said retrieved third party information and information received from said potential customer and determining an assessment value indicating eligibility of said potential customer for said insurance policy.

35. The system of claim 34 wherein said third party information and said information retrieved from said potential customer include a plurality of risk data items relating to eligibility of said potential customer for said insurance policy, and said evaluation means includes:
assignment means for determining and assigning a risk value to each risk data item relating to said potential customer; and
value means for accumulating each assigned risk value to produce a total value representing said assessment value.

36. The system of claim 34 wherein said assessment means further includes:
underwriting means for comparing said assessment value to a policy threshold value and determining eligibility of said potential customer for said insurance policy based on said comparison.

37. The system of claim 36 wherein said policy means includes:
price means for determining a price of said insurance policy based on a difference between said assessment value and said policy threshold.

38. The system of claim 37 wherein said policy means further includes:
price reduction means for determining a reduction in said insurance policy price in accordance with additional information supplied by said potential customer.

39. The system of claim 27 wherein said policy means includes:
offer means for enabling said potential customer to purchase said insurance policy in response to said assessment means determining that said potential customer is eligible for said insurance policy;
payment means for receiving and validating payment information from said potential customer in response to acceptance of said insurance policy by said potential customer; and
issuance means for issuing said insurance policy over said network to said potential customer in response to valid payment information.
